(19) United States
(12) Patent Application Publication
(10) Pub. No.: US 2024/0223564 A1
(43) Pub. Date: Jul. 4, 2024

(54) SYSTEM AND METHOD FOR CONNECTED AQUATIC DEVICES

(71) Applicant: Pentair Water Pool and Spa, Inc., Cary, NC (US)

(72) Inventors: Keith Lewis, New Hill, NC (US); Umesh Pai, Apex, NC (US)

(21) Appl. No.: 18/397,637

(22) Filed: Dec. 27, 2023

Related U.S. Application Data
(60) Provisional application No. 63/477,803, filed on Dec. 29, 2022.

(51) Int. Cl. H04L 9/40

(52) U.S. Cl. CPC H04L 63/101; H04L 63/108

(57) ABSTRACT

A system and method for connected aquatic devices are provided. The system includes a controller designed to execute programmable instructions to control and manage requests and data received from disparate applications. The controller can be connected to one or more pool components of a connected aquatic system and one or more disparate applications. The system can receive and process requests from the disparate applications, including processing third-party data, to provide or limit access and control to the pool components, spa components, or other aquatic devices.

### CROSS-REFERENCE TO RELATED APPLICATIONS

This application claims priority to U.S. Provisional Patent Application Ser. No. 63/477,803, filed on Dec. 29, 2022, entitled “SYSTEM AND METHOD FOR CONNECTED AQUATIC DEVICES,” currently pending, the entire disclosure of which is incorporated herein by reference.

### FIELD OF DISCLOSURE

The present disclosure relates generally to a connected aquatic system for use in residential and short-term rental applications.

### BACKGROUND

Existing pool and spa systems lack the ability to integrate or communicate between multiple applications and platforms to limit access and control of aquatic devices or equipment associated with an aquatic system. This can be especially important for rental homes with a pool or spa or for temporary rentals. Owners or hosts of rental homes with a pool or spa want to ensure that only authorized users have access to a pool or spa on the rental property for purposes of safety, rates, and liability. The ability to limit the types of parameters a short-term renter has permission to change is desirable. For example, a user may allow a short-term renter the ability to turn a pool or spa on/off during the duration of their stay, but not allow them to change the temperature or other parameters. Existing systems also lack the ability to dynamically integrate aspects of an aquatic system using a scalable structure that can be used with a plurality of applications, data types, and data formats.

Additionally, it can be very difficult for someone who does not own a pool or spa system to visualize how a pool or spa may look on their property or determine which pool or spa layout or equipment to select. Existing systems lack the ability to spatially visualize an aquatic system and associated aquatic equipment components, before hiring a pool expert or builder. A system that enables a user to see a potential pool or spa layout and associate aquatic equipment virtually on a property is therefore desirable.

### SUMMARY

Embodiments described herein are generally directed to a connected aquatic system. The connected aquatic system comprises aquatic equipment system components, like pool and spa devices, that are designed to be managed and controlled by a central controller. More specifically, the aquatic equipment system components can be controlled when a user has an appropriate access level during a time period, as determined by an authentication system of the connected aquatic system. Additionally, in some embodiments, the aquatic equipment system components can connect to each other and to the central controller that collects and stores data sets, which can then be processed to update parameters of the one or more aquatic equipment system components according to the access level of a user submitting a request. In some embodiments, data in the data sets may be processed according to information in the data set related to the format of the output requested. In some embodiments, the data sets can include data from disparate applications, like third-party applications and services. In some embodiments, the connected aquatic system further includes a notification system for generating and transmitting one or more notifications to a user device and other aspects of the connected aquatic system.

In one aspect, a connected aquatic system for managing requests from one or more disparate applications is provided. The connected aquatic system includes a pool component and a central controller that is in communication with the pool component. The central controller is designed to execute programmable instructions. The programmable instructions can include connecting the pool component to a cloud-based server via a network. The programmable instructions can also include establishing a communication link between the cloud-based server and a disparate application. The instructions can further include receiving a request from the disparate application, wherein the request includes a plurality of third-party data. The instructions can also include providing access to the pool component based on the plurality of third-party data in response to receiving the request. The third-party data may include an access level.

In some aspects, the system further includes an authentication system that is in communication with the central controller. The authentication system can determine the access level, and the access level is associated with a user. In some forms, a request for a user to update a parameter of the pool component is received by the central controller via the disparate application. The parameter can include turning the pool component on or off. In some aspects, the request is sent to an authentication system in communication with the controller to determine if the access level permits the user to update the parameter of the pool component. The system can also include a notification system that is in communication with the controller. The notification system can generate a notification that the parameter of the pool component is updatable by the user based on the access level and sends the notification to a user device via the controller. In some embodiments, the pool component can be provided in the form of a pool pump, a booster pump, a filter, a solar controller, one or more solar panels, a heater, a sanitizer, a water quality monitor, a pH regulator, a salt chlorine generator, a water feature, a pool cleaner, a pool skimmer, a pool drain, a pool light, one or more valves, and one or more sensors. In some forms, the disparate application can be provided in the form of an application for payment services, calendaring services, scheduling services, short-term rental services, virtual reality platform services, contracting services, pool equipment dealer services, pool chemical services, or a combination thereof. In some aspects, the third-party data also includes a unique identifier for a user and a time period for the access level, wherein the access level and the time period for the access level are associated with the unique identifier for the user. In some aspects, the system further includes a database that is in communication with the central controller.

In another aspect, a method of communicating between disparate applications within a connected aquatic system is provided. The method can include providing a pool component in communication with a controller. The controller can connect the pool component to a cloud-based server via a network. The controller can also establish a communication link between the cloud-based server and a disparate application. The controller can receive a request from the disparate application wherein the request includes a plurality of third-party data. The method can also include providing access to the pool component in response to receiving the request, where access is based on the plurality of third-party data. The third-party data can be associated with a particular access level.

In some forms, the method also includes monitoring and reporting parameters associated with the pool component to the disparate application. The parameters associated with the pool component can include usage data for the pool component. In some embodiments, an authentication system in communication with the controller can authenticate a user. The authentication process can include determining whether the access level associated with a user enables the user to change the parameters associated with the pool components. The method can also include sending a notification to a user device of the user via a notification system in communication with the controller. The notification indicates that the user can change the parameters associated with the pool component based on the access level. In some embodiments, the disparate application comprises an application for one or more of payment services, calendaring services, scheduling services, short-term rental services, virtual reality platform services, contracting services, pool equipment dealer services, or pool chemical services.

In another aspect, a system for communicating between disparate applications within a connected aquatic system is provided. The system can include a pool component in communication with a central controller. The central controller can be designed to control the pool component upon receipt of an authorized request. The system can also include a cloud-based server operatively connected to the controller and the pool component. The system can further include a connection to a disparate application provided in a form of a third-party application. The system can also include an authentication system designed to process a request from the disparate application. The request can include access level data. The system can also include a database designed to store authorized user information and a processor of the central controller designed to execute programmable instructions. The programmable instructions can include comparing the access level data to the authorized user information and determining whether to authenticate the request based on whether the access level data matches the authorized user information. The processor can also generate a notification to the central controller when the request is the authorized request based on determining the access level data matches the authorized user information.

These and other aspects and advantages of the present disclosure will become apparent to those skilled in the art after considering the following detailed description in connection with the accompanying drawings.

### BRIEF DESCRIPTION OF DRAWINGS

FIG. 1 is a block diagram of an embodiment of a system architecture of a connected aquatic system;

FIG. 2 is a block diagram of an embodiment of aquatic equipment system components of the connected aquatic system of FIG. 1;

FIG. 3 is a block diagram of an embodiment of a connected sensor and a central controller of the connected aquatic system of FIG. 1;

FIG. 4 is a block diagram of an embodiment of a data management system of the connected aquatic system of FIG. 1;

FIG. 5 is a flow diagram of an embodiment of a data management process of the connected aquatic system of FIG. 1;

FIG. 6 is a flow diagram of an embodiment of an authentication process of the connected aquatic system of FIG. 1;

FIG. 7 is a flow diagram of an embodiment of a device parameter update process of the connected aquatic system of FIG. 1; and

FIG. 8 is a flow diagram of an embodiment of a system reset process of the connected aquatic system of FIG. 1.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components outlined in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

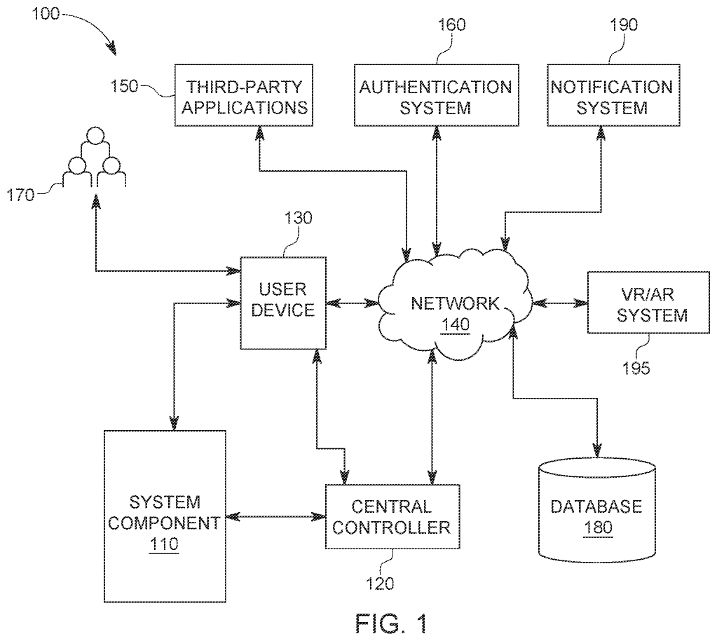

FIG. 1 illustrates an exemplary connected aquatic system 100 (hereinafter “connected system”), according to disclosed embodiments. When used throughout the disclosure, it will be understood by one skilled in the art that an “aquatic system” may include, for example, a pool or spa system, or similar.

As shown in FIG. 1, the connected system 100 may include one or more aquatic equipment system components 110, a central controller 120, one or more user devices 130, and a network 140 designed to communicate with one or more third-party applications 150 and other aspects of the connected system 100. The connected system 100 may include an authentication system 160 designed to execute an authentication process to authenticate one or more users 170 via the third-party applications 150. In addition, the connected system 100 may include a database 180 and/or one or more data models. The connected system 100 may further include a notification system 190 designed to generate and transmit notifications to the one or more user devices 130 and other aspects of the connected system 100. In some embodiments, the notification system 190 generates and transmits notifications via the central controller 120. In further embodiments, the connected system 100 may include other systems such as a virtual reality (VR) or augmented reality (AR) (hereinafter referred to collectively as “VR/AR”) system 195.

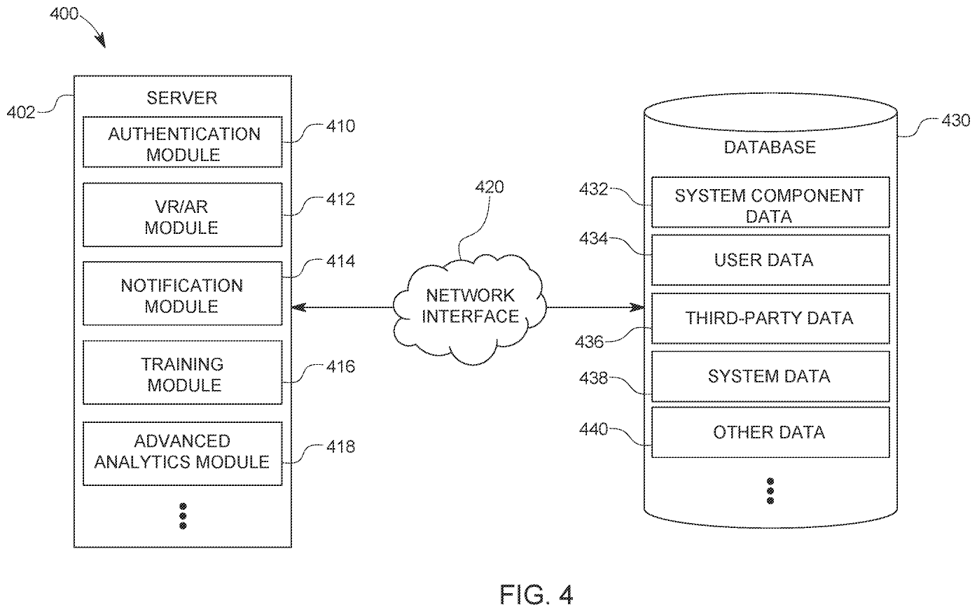

In some embodiments, the authentication system 160 and the notification system 190 may be separate systems connected to the controller 120 via the network 140. In other embodiments, the authentication system 160 and the notification system 190 may be provided in the form of individual modules 410, and 414 within a data management system 400 of the connected system 100 (as shown in FIG. 4).

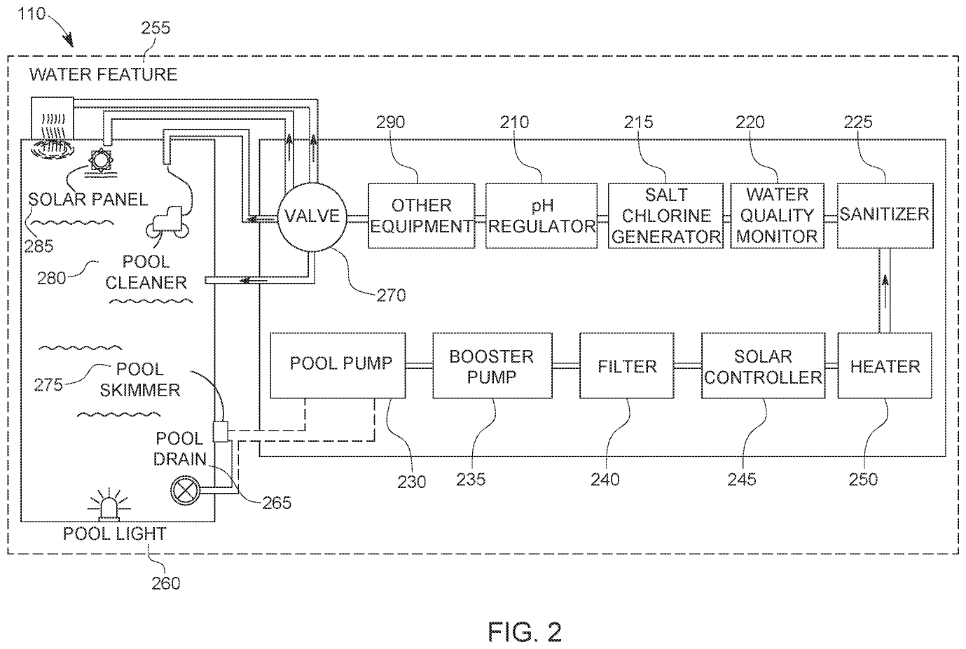

The one or more aquatic equipment system components 110 (hereinafter “system component(s)”) may include any residential device having a communication port, radio, wired, or wireless communication module. In addition, as described in more detail in connection with FIG. 2, the one or more system components 110 can include, for example, one or more pool equipment devices, one or more sensors, one or more valves, one or more pumps having a variable frequency drive (VFD) and/or variable speed drive (VSD), one or more monitoring devices and/or detectors, several communication enabling devices, and/or other electrically controllable pool or spa related devices (e.g., any components shown in connection with FIG. 2).

The one or more system component(s) 110 may be in communication with other aspects of the connected system 100 to send and receive data sets and may otherwise be connected to provide dynamic monitoring and control of various aspects of the connected system 100. When used throughout the present disclosure, it will be recognized by one skilled in the art that “data sets” may include, but are not limited to, one or more data elements, single variable data, data points, measurements, settings, configurations, parameters, commands, notifications, metrics, readings, a similar data component, any other information or data, or any combination thereof.

In some embodiments, the central controller 120 may be provided in the form of a data-processing device located proximate to the connected system 100 and designed to transmit and receive data from the one or more system components 110. For example, the central controller 120 may be provided in the form of a pool-side controller, a spa-side controller, or similar. In some embodiments, the central controller 120 may act as a network interface to create a communication link that operatively connects the one or more system components 110 and the one or more user devices 130 over the network 140. In some forms, the central controller 120 may create a communication link that operatively connects the one or more system components 110 to third-party applications 150 over the network 140. The one or more system components 110 may also be connected to the one or more user devices 130 or the third-party applications 150 via a network such as the network 140 or a different network. In another embodiment, the one or more system components 110 may act as a network interface and create a communication link directly to the other system components 110 and the central controller 120. In some embodiments, the central controller 120 may be provided in the form of a gateway, hub, router, server, switch, or other connected devices to allow integration, monitoring, and control of multiple aspects of the connected system 100. For example, in one non-limiting embodiment, the central controller 120 may be integrated with, or otherwise connected to a server 402. The server 402 may be a physical server or a cloud-based server and may include a processor designed to execute programmable instructions. The one or more individual system components 110 may likewise be configured to monitor and control the other aspects of the connected system 100.

In some embodiments, the one or more system components 110 may interface with the one or more user devices 130 either directly over a wired or wireless connection or a connection via the central controller 120. The one or more user devices 130 may also interface with the central controller 120 either directly over a connection or a connection via the network 140. Similarly, the central controller 120 may include a control system and/or processing system. In some embodiments, the central controller 120 may interface with the control system and/or processing system via a connection to the network 140 or a connection between one or more of the system components 110.

The one or more user devices 130 may be any device capable of connecting to the Internet via a wired or wireless communication link. In one embodiment, the one or more user devices 130 may be provided in the form of a portable computing device like a smartphone, tablet, computer, or another display interface. The one or more user devices 130 may include or be otherwise connected to, a programmable processor, a network interface, data capture elements, and a memory unit. In some embodiments, the data capture elements may include a microphone, a camera, a vibration sensor, or any combination thereof. The user device may include a Wi-Fi, Bluetooth, cellular, or similar wired or wireless communication link used to communicate with the network 140 or other networks. Furthermore, the one or more user devices 130 may include program instructions that are stored on a non-transitory computer-readable medium and may be executed by the programmable processor 306 to perform the processes described herein. In one non-limiting embodiment, the one or more user devices 130 may be provided in the form of an outdoor control panel, such as a poolside or spa-side keypad or similar control interface.

The one or more system components 110 of the connected system 100 may communicate directly with one another using a network interface, local network, or other communication connection, and are not limited to the communication connections and network 140 shown in FIG. 1. In some embodiments, the communication connection may be provided in the form of a wireless module integrated with or coupled to the one or more system components 110. One skilled in the art will recognize that a communication connection may include, for example, a connection that can transmit and receive data using a communication protocol. Non-limiting examples of the communication connection include wired, wireless, Bluetooth, cellular, satellite, GPS, RS-485, RF, MODBUS, CAN, CANBUS, DeviceNet, ControlNet, Ethernet TCP/IP, RS-232, Universal Serial Bus (USB), Firewire, Thread, proprietary protocol(s), or other known communication protocol(s) as applicable.

The network 140 may include, for example, the Internet, intranets, extranets, wide area networks (WANs), local area networks (LANs), wired networks, wireless networks, cloud networks, or other suitable networks, or any combination of such networks. For example, such networks may include satellite networks, cable networks, Ethernet networks, and other types of networks. In one embodiment, the network 140 may be an isolated private network utilizing a private IP address and limiting access to the network. In some embodiments, the network 140 may include one or more computing devices that may be arranged, for example, in one or more server banks, computer banks, or other arrangements. Information related to the network 140, including connectivity status, speed, security, connected devices, wireless interface, etc. may be communicated to other aspects of the connected system 100 as a data set.

The third-party applications 150 may include, but are not limited to, one or more applications for payment services, calendaring services, scheduling services, short-term rental services, virtual reality platform services, contracting services, pool equipment services, pool chemical services, combinations thereof, and the like. In one non-limiting embodiment, the third-party applications 150 may interface with the central controller 120 over the network 140 or via a different network to send and receive data items, notifications, information, status updates, requests, and/or modifications to any of the third-party applications 150. The one or more users 170 may interface with the third-party applications 150 using the one or more user devices 130 or another computing device via the network 140 or another network.

The authentication system 160 may confirm the identity and account details of a user 170 by one or more validation techniques. The authentication system 160 may be provided in the form of a web server, which may be one or more of a combination of hardware, software, virtual machine, or similar device that stores, processes, validates, and delivers data to computing devices, including aspects of the connected system 100 and third-party applications 150. The authentication system 160 may be communicatively coupled to the central controller 120 via the network 140. The authentication system 160 may also be communicably coupled to a database such as the database 180 or another database. The authentication system 160 may use, as non-limiting examples, a username, and password, personalized token, personal identification number, or biometric data to validate system access associated with a particular user 170. The authentication system 160 may also be configured to associate a unique identifier with each user 170, wherein the unique identifier may be used throughout the processes described herein. The unique identifier may further be used to indicate a specific access level assigned to a particular user 170 for a specified time period.

In further embodiments, the authentication system 160 may be integrated with or otherwise coupled to an existing property security system and/or device. Thus, a user 170 who has access to the property via the property's security system or device may be given a specific access level to some or all of the one or more system components 110 without having to separately register with the authentication system 160.

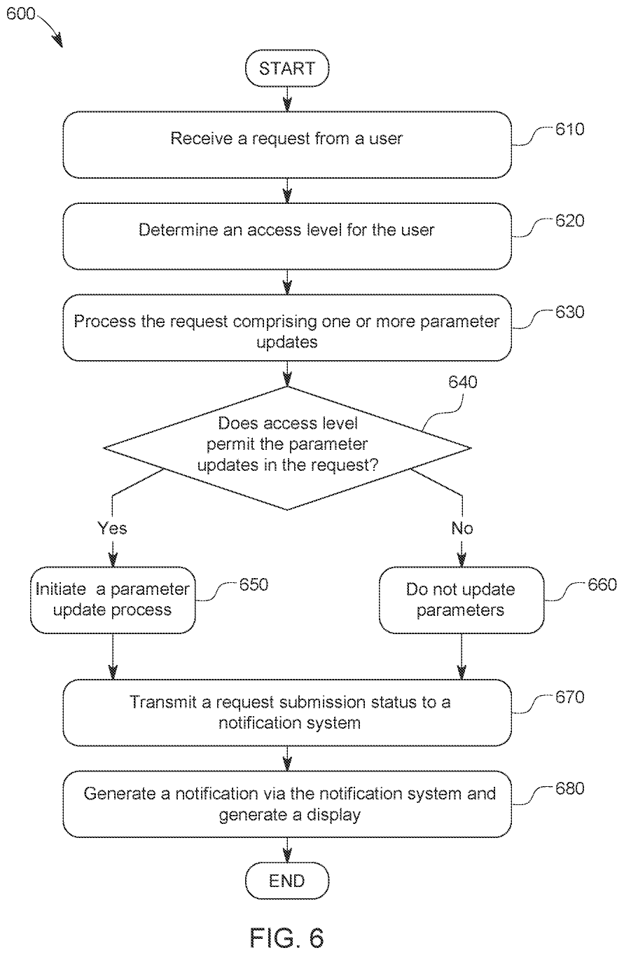

A user 170 may install an application (e.g., the one or more of the third-party applications 150) on the one or more user devices 130 or other portable devices or display interfaces to access data associated with a user account. A user 170 may set up the user account when the user 170 registers or is authenticated for access to the connected system 100. The user 170 may further configure other aspects of the connected system 100 to be associated with a given user account to send and receive data associated with the user's specific system components 110. A user account may contain personal information including user data processed by the connected system 100 as information extracted from a data set, as described in more detail in connection with the authentication process of FIG. 6. It will be understood by one skilled in the art that “account” may also mean record, profile, or similar.

The central controller 120 may receive data from the one or more system components 110, the one or more user devices 130, third-party applications 150, the authentication system 160, and the notification system 190, extract data elements from the data, and store the data elements in the database 180 of the connected system 100. In some embodiments, the data may be received in the form of a new request or an event. In some embodiments, the database 180 may extract information from the data according to characteristics, parameters, settings, or similar configurations associated with a single data element or a particular system component 110. For example, one of the system components 110 may transmit a system component data set containing system component data 432 (see FIG. 4) to the central controller 120. In other embodiments, the one or more user devices 130 may transmit a user data set containing user data 434 to the central controller 120, and/or the third-party applications 150 may transmit a third-party data set containing third-party data to the central controller 120. In further embodiments, the authentication system 160 and/or the notification system 190 may send other data sets containing other data 440 to the central controller 120. The central controller 120 may receive one or more of the transmitted data sets and extract data according to a characteristic, including but not limited to sensor data, an identification element for the system component data, user data, third-party data, usage data, an error code, system data 438 (see FIG. 4), etc. In some embodiments, the extracted data may be transmitted from the central controller 120 and stored in the database 180, lookup table, or similar (see, e.g., FIG. 4).

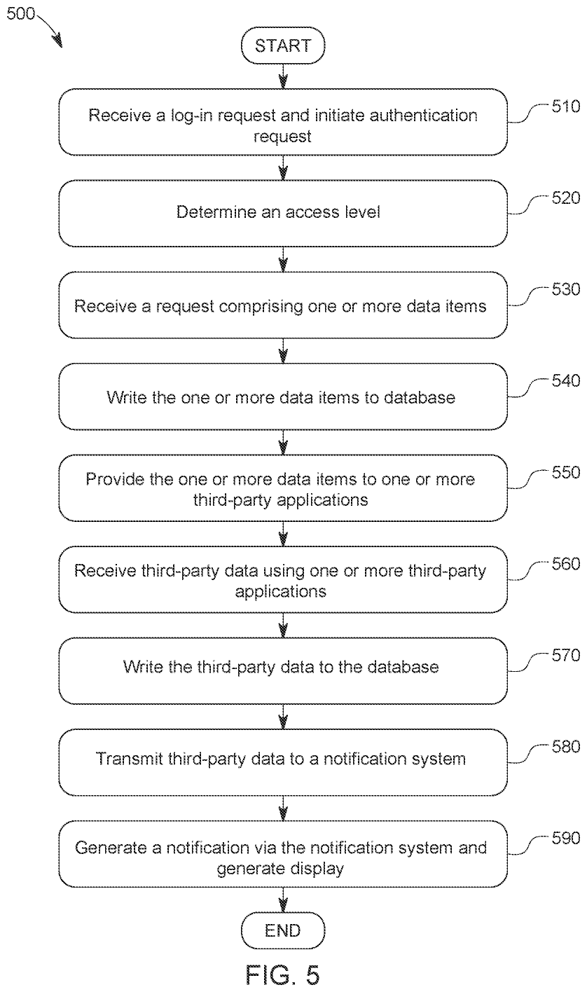

As described in connection with FIG. 5, the transmitted data sets may be processed by the database 180. The database 180 generally refers to a dynamic and scalable data model that connects or integrates with internal or external systems, databases, data sources, or other platforms from which various data may be received or collected. In certain embodiments, the database 180 may include one or more memory devices, processors, and/or controllers. The database 180, in some embodiments, may store data received via the central controller 120 or another aspect of the connected system 100 including system component data, user data, third-party data, system data, and/or other data (see, e.g., FIG. 4).

The notification system 190 may be designed to generate, transmit, and/or receive alerts or notifications related to the operation, functionality, and maintenance of the one or more system components 110 and other aspects of the connected system 100. The notification system 190 may also be used to send and receive information to and from the third-party applications 150, the one or more user devices 130, and/or the authentication system 160, in one example. In some embodiments, the notification system 190 may be connected to the central controller 120 via the network 140 or another network. The notification system 190 may also be connected to a database such as database 180 or another database via the network 140 or another network.

The notification system 190 may be provided in the form of an application for creating, modifying, executing, and logging requests. The notification system 190 may also generate, update, and push notifications to one or more devices or applications, including but not limited to the third-party applications 150 and the one or more user devices 130. In some embodiments, the notification system 190 may be configured to be dynamic, scalable, and integrated with a plurality of third-party applications 150. The notification system 190 may be configured to receive data items from the one or more system components 110, the one or more user devices 130, the authentication system 160, or the third-party applications 150 and handle the notification generation and management for all aspects of the connected system 100.

As described in more detail with respect to FIGS. 4-8, the notification system 190 (or notification module 414) may be configured to create and monitor new requests or events, wherein each new request or event may be assigned a unique identifier. The request or event may further include a time stamp. Each request or event may have one or more subtasks or related requests, each with an individual status, time stamp, and identification. A notification status may be updated automatically via the central controller 120, or in response to receiving an input from the user 170 or other indication that the request or event has been modified or that the request or event has been submitted or updated.

As shown in FIG. 2, the one or more system components 110 may include one or more devices utilized for operating and maintaining a residential aquatic system like a pool or spa. For example, the one or more system components 110 may include a pH regulator 210, a salt chlorine generator 215, a water quality monitor 220, a sanitizer 225, a pool pump 230, a booster pump 235, a filter 240, a solar controller 245, a heater 250, a water feature 255, a pool light 260, a pool drain 265, a pool skimmer 275, a pool cleaner 280, one or more solar panels 285, and/or other controllable pool or spa related devices or other equipment 290. The one or more system components 110 may further include one or more valves 270 to control the individual system components 110. The one or more valves 270 may be controlled manually or remotely via the one or more user devices 130, the central controller 120, individual system components 110, or any combination thereof. The one or more valves 270 may be disposed of at various locations throughout the pool or spa plumbing to control the flow of fluid through the fluid circuit formed by the one or more system components 110 of the connected system 100.

Each of the one or more system components 110 can include a unique identification code. The unique identification code may be assigned by the manufacturer, include a product serial number, be assigned when a user registers the component, or otherwise be associated with a user record after installation. In some examples, a user could scan a receipt, barcode, QR code, RFID tag, serial number, or another identification code on the system component(s) 110 or the packaging to register the one or more system components 110 with a user account. In one embodiment, the identification code associated with system component data 432 can be extracted and stored in the database 430 (see FIG. 4), lookup table, or similar. In some forms, the system can identify the system component 110 using image processing techniques, object detection and identification, virtual reality or augmented reality, or other techniques.

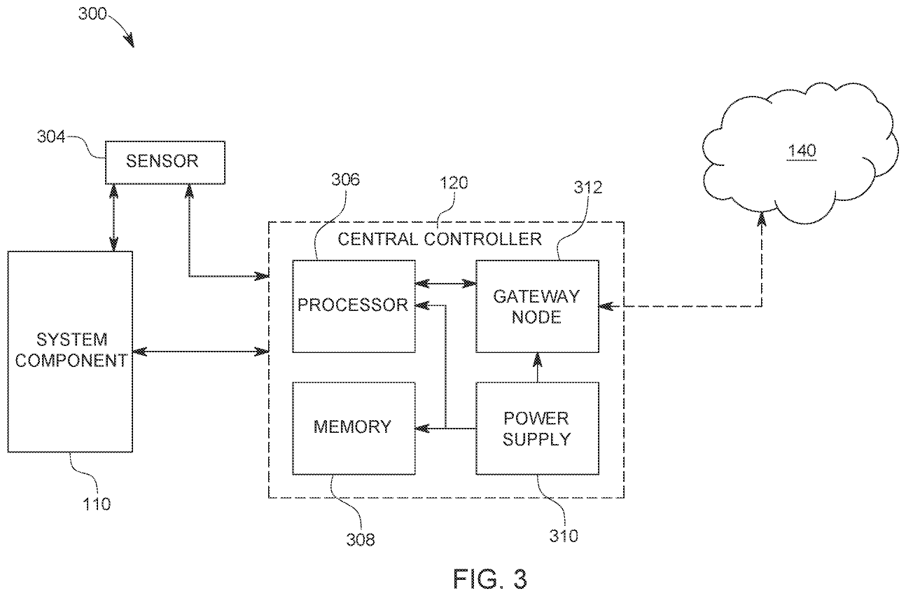

Each of the one or more system components 110 may further include one or more sensors, monitoring devices, and/or other communication-enabled devices to monitor and control the one or more individual system components 110. In some embodiments, one or more sensors may be provided in the form of an integrated sensor, an external sensor 304 coupled to or in communication with the system components 110 (as shown in FIG. 3), or both. It will be understood by those having skill in the art that the term “sensor” as used throughout the specification can include several variations of sensing devices, sensing device configurations, or other monitoring devices. In some embodiments, a sensor can be provided in the form of a sensor unit with one or more individual sensors, a single sensor with multiple sensing capabilities, or a combination of these.

In another non-limiting example, the pH regulator 210 may include one or more sensors 304 that can be designed to detect power, voltage, current, level, chemistry, flow, or a combination thereof. The power sensor can measure whether or not the pH regulator 210 is connected to power, and/or whether it is activated. The voltage sensor can monitor the input voltage and detect any upstream electrical system faults. The current sensor can measure the current in the pH regulator 210 system to verify the circuit is working properly. Abnormal current measurements and/or an abnormal power consumption reading may indicate a malfunction. A chemical tank level associated with the pH regulator 210 can be measured by a level sensor, such as but not limited to a float switch, force sensor, or similar. The chemical sensor can be used to identify chemical properties within the chemical tank. In some embodiments, one or more electrodes, or similar, may be used to measure a difference in the electrical potential between a pH electrode and a reference electrode. The flow sensor can include a flow switch and/or a fluid velocity sensor to measure a rate at which chemicals are dispensed through the pH regulator 210 system. In some embodiments, the flow sensor may also be integrated with, or otherwise communicate with, the chemical sensor to measure the type and quantity of chemical(s) dispensed. In some embodiments, an encoder may be used to measure, monitor, and/or detect the rotational position and velocity of a dispensing component of the pH regulator 210.

In another non-limiting example, the salt chlorine generator 215 may include one or more sensors 304 that can be designed to detect power, voltage, flow, resistance, water chemistry, or a combination thereof. The power sensor can measure whether or not the salt chlorine generator 215 is connected to power, and/or whether it is activated. The voltage sensor can monitor the input voltage and detect any upstream electrical system faults. The voltage sensor can also measure a battery level if the salt chlorine generator 215 is battery-powered or includes a battery pack. The flow sensor can also include a flow switch and can monitor water flow at an input and/or an output of the salt chlorine generator 215 and can identify potential clogs in the system. The flow sensor can further determine if the flow velocity is sufficient for proper operating conditions for the salt chlorine generator 215.

In another non-limiting example, the water quality monitor 220 may include one or more sensors 304 that can be designed to detect power, voltage, flow, resistance, water chemistry, or a combination thereof. The power sensor can measure whether or not the water quality monitor 220 is connected to power, and/or whether it is activated. The voltage sensor can monitor the input voltage and detect any upstream electrical system faults. The voltage sensor can also measure a battery level if the water quality monitor 220 is battery-powered or includes a battery pack. The flow sensor can also include a flow switch and can monitor water flow at an input and/or an output of the water quality monitor 220 and can identify potential clogs in the monitoring system. The flow sensor can further determine if the flow velocity is sufficient for proper operating conditions for the water quality monitor 220.

In another non-limiting example, the sanitizer 225 may include one or more sensors 304 that can be designed to detect power, radiant energy, resistance, voltage, current, pressure, or a combination thereof. The power sensor can measure whether or not the sanitizer 225 is connected to power, and/or whether it is activated. In some embodiments, the sanitizer 225 is an Ultraviolet (UV) Light sanitizing device and a photosensor can be used to measure the radiant energy of the sanitizer 225 to also determine if the sanitizer is activated. The resistance sensor can determine the electrical resistance across the UV bulb to verify the bulb is properly installed and is within a functional range. Irregular resistance measurements can indicate a replacement bulb is recommended for the sanitizer 225. The voltage sensor can monitor an input voltage and detect any upstream electrical system faults. The voltage sensor can also measure voltage drop to determine the power consumption of the sanitizer 225. The current sensor can measure the current in the sanitizer 225 system to verify the circuit is working properly. Low or non-existent current measurements may indicate a replacement bulb is recommended for the sanitizer 225. The pressure sensor measures differential pressure to detect scale or fouling through a water passage in the sanitizer 225.

As a non-limiting example, the pool pump 230 and/or booster pump 235 may include one or more sensors 304 that can be designed to detect power, vibration, current, flow, pressure, temperature, frequency, or a combination thereof. The power sensor can measure whether or not the pool pump 230 and/or booster pump 235 is connected to power, and/or whether it is activated. Additionally, some pool pumps 230 and booster pumps 235 have a soft start mode or similar controlled or reduced power mode, which can be measured and detected by the power sensor. The vibration sensor can measure vibration levels to identify electromagnetic or mechanical imbalance, loose components, rubbing parts, part failure, cavitation, or resonance. Some embodiments may further include an accelerometer to detect if the pump becomes unlevel. The current sensor can measure current flowing through the system using a non-intrusive method. The flow sensor can measure a flow of water that is pumped by a motor of the pool pump 230 and/or booster pump 235 and determines the actual health of the motor by determining if the flow rate is unexpectedly high or low based on the particular application and several threshold metrics. The flow sensor can also include a flow switch and/or a fluid velocity sensor to detect abnormal flow rates. The pressure sensor may monitor pressure in air compressors, irrigation systems, and heat exchangers that all use pumps to push air or water through their respective systems. The pressure sensor may further measure an input and differential pressure at the head of the pool pump 230 and/or booster pump 235. The one or more sensors 304 help to overcome the faults and monitor the pool pump 230 and/or booster pump 235. Further, the temperature sensor monitors the temperature and helps to detect any abnormal temperature rise due to any malfunction or failure, which can include but is not limited to temperature measurements at the inlet, outlet, and motor. The frequency sensor can measure the frequency of the pool pump 230 and/or the booster pump 235 and can be used for controlling VFDs that may be associated with or connected to either the pool pump 230 and/or booster pump 235. In some embodiments, an encoder may be used to measure and/or monitor the velocity of a rotor/impeller of the pool pump 230 and/or booster pump 235. Other sensors such as the voltage sensor can also monitor the input voltage and calculate the power factor of a motor of the pool pump 230 and/or the booster pump 235 using both current and voltage values of the connected system 100 and/or the values detected by the one or more sensors 304 connected to each of the pool pump 230 and/or the booster pump 235.

In another non-limiting example, the filter 240 may include one or more sensors 304 that can be designed to detect pressure, flow, fluid velocity, or a combination thereof. The pressure sensor can detect and monitor differential pressure to identify when the filter may be dirty or clogged with debris. Routine maintenance alerts can be provided to regularly clean the filter 240 and extend the life of the filter 240. The flow sensor may include a flow switch and/or a fluid velocity sensor to measure the flow status and flow rate at the inlet, outlet, and backwash ports of the filter 240. Additionally, the flow sensor can measure a flow rate to help detect potential leaks in the filter 240 and in the filter compartment (not shown).

In another non-limiting example, the solar controller 245 may include one or more sensors 304 that can be designed to detect voltage, current, temperature, or a combination thereof. The power sensor can measure whether or not the solar controller 245 is connected to power, and/or whether it is activated. The voltage sensor can monitor the input voltage and detect any upstream electrical system faults. The voltage sensor can also measure the control voltage and verify the output signal to a solar valve actuator is within a functional range (e.g., ˜0-24V), and can verify the solar controller 245 relay voltage is within a functional range (e.g., ˜0-230 VAC). The temperature sensor can be used to monitor an internal temperature of the solar controller 245 and identify if any internal components, including electronic components, are overheating.

In another non-limiting example, the heater 250 may include one or more sensors 304 that can be designed to detect power, voltage, current, temperature, pressure, or a combination thereof. The power sensor can measure whether or not the heater 250 is connected to power, and/or whether it is activated. The voltage sensor can monitor the input voltage and detect any upstream electrical system faults. The voltage sensor can also measure voltage drop to determine the power consumption of the heater 250. The current sensor can detect potential short circuits in the heater 250 by identifying abnormal power consumption and/or current spikes. The temperature sensor can be used to monitor the internal temperature of the heater 250 including the heating elements (not shown). The temperature sensor can also measure the temperature at an inlet and an outlet to verify the water temperature is being heated according to the heater 250 controls and settings. The pressure sensor can measure differential pressure to identify scale or fouling through a water passage in the heater 250.

In another non-limiting example, the water feature 255 may include one or more sensors 304 that can be designed to detect power, flow, pressure, or a combination thereof. The power sensor can measure whether or not the water feature 255 is connected to power, and/or whether it is activated. The flow sensor can include a flow switch and/or fluid velocity sensor, or similar, to measure the fluid/water flow rate through the water feature 255. The pressure sensor can be used to detect a water depth at a bottom surface of the water feature 255. The pressure sensor may also communicate with the flow sensor to measure the flow rate through the water feature 255.

In another non-limiting example, the pool light 260 can include one or more sensors 304 that can be designed to detect power, voltage, current, temperature, resistance, or a combination thereof. The power sensor can measure whether or not the pool light 260 is connected to power, and/or whether it is activated. The voltage sensor can measure the input voltage to the pool light 260 and detect any upstream electrical system faults. The current sensor can measure the current through the pool light 260 and can be used with the voltage sensor to measure power consumption. The voltage and/or current sensor can also detect when there is an abnormal power consumption measurement, which may indicate a malfunction with the pool light 260. In some embodiments, the pool light 260 may include one or more pool lights and can also include advanced lighting controls such as animation, color, dimming, timer controls, etc. The advanced lighting control features for the pool light 260 can include one or more sensors 304 to detect and measure system variables and/or operating parameters associated with the one or more lighting control features. In some embodiments, the resistance can also be measured to identify electrical shorts, faults, or when a light bulb or diode should be replaced.

In another non-limiting example, the pool drain 265 may include one or more sensors 304 that can be designed to detect temperature, flow, pressure, or a combination thereof. The temperature sensor can measure the temperature of the water output flowing through the pool drain 265. The flow sensor may include a flow switch and/or fluid velocity sensor, or similar, to measure the flow rate of water through the pool drain 265. The pressure sensor may measure a pool water level. The pressure sensor can also measure differential pressure to detect if the pool drain 265 may be clogged.

In another non-limiting example, the one or more valves 270 may include one or more sensors 304 that can be designed to detect voltage, current, position, flow, or a combination thereof. The voltage sensor can monitor the input voltage and detect any upstream electrical system faults. The voltage sensor can also measure the control voltage and verify the output signal to a valve 270 actuator is within a functional range (e.g., ˜0-24V). The current sensor can measure the current in the one or more valves 270 system and detect if there is an abnormal current measurement. Abnormal current measurements and/or an abnormal power consumption reading may indicate a malfunction in the valve 270. The position of a valve 270 actuator and/or shaft can be detected using a position sensor, encoder, or similar. The flow switch can measure the flow rate through the one or more valves 270 and detect if a valve port is not receiving an expected flow.

In another non-limiting example, the pool skimmer 275 may include one or more sensors 304 that can be designed to detect pressure. A differential pressure sensor can detect if there is a clog in a skimmer basket of the pool skimmer 275 or if debris is interfering with air being induced in an equalizer line of the pool skimmer 275. In some embodiments, an encoder may be used to detect a position of a weir installed in the pool skimmer 275.

In another non-limiting example, the pool cleaner 280 may include one or more sensors 304 that can be designed to detect: power, voltage, pressure, if debris should be emptied from the cleaner 280, or a combination thereof. The power sensor can measure whether or not the pool cleaner 280 is connected to power, and/or whether it is activated. The voltage sensor can monitor the input voltage and detect any upstream electrical system faults. The pressure sensor can measure a suction level in a suction line of the pool cleaner 280. An encoder can be used to detect if the one or more spinning motors of the pool cleaner 280 are rotating properly. As with the other system components 200 described herein, the monitored measurements may vary depending on the manufacturer and type of the pool cleaner 280.

In another non-limiting example, the one or more solar panels 285 may include one or more sensors 304 that can be designed to detect: power, voltage, current, solar radiation, or a combination thereof. The power sensor can measure whether or not the one or more solar panels 285 are activated. The voltage and current sensors can be used to detect the power generation of the one or more solar panels 285. In addition to the data analytics techniques described herein, these measurements can be used to produce energy reports and historical usage data that can be displayed on the one or more user devices 130. A photosensor can be used to detect levels of solar radiation (e.g., whether it is a sunny day or a cloudy day).

In another non-limiting example, the other equipment 290 may include one or more sensors 304 that can be designed to detect one or more operating parameters associated with components of the other equipment 290 (e.g., power status, operational mode, flow, pressure, chemical composition, calibration status, and other parameters).

FIG. 3 illustrates a system view of one embodiment of the central controller 120 connected to or otherwise in communication with the one or more system components 110, to illustrate an example of a connected sensor system 300 for the one or more system components 110 within the connected system 100. As described in connection with FIG. 2, the system components 110 may include an integrated sensor 304 or otherwise be connected to an external sensor. The central controller 120 may, in certain embodiments, send and receive information from the one or more system components 110 (e.g., any operational parameter or setting regardless of whether it is measured via a sensor) via the network 140.

In one embodiment, the sensor 304 (including but not limited to any of the sensing components or monitoring devices discussed above) can collect and/or send one or more data sets associated with the operating parameters and historical data of the one or more system components 200 continuously (or substantially continuously), at scheduled intervals, or in response to a request or other system event. In this example, the request or system event can include a user input received by the one or more user devices 130. For example, if a user wanted to check the temperature of the pool or spa, the one or more user devices 130 could process this request and transmit a command to a sensor in communication with the pool or spa water, to collect the current temperature reading and transmit the information back to the one or more user devices 130 and process the one or more data sets to generate a display to be displayed on the one or more user device 130. It should be appreciated that the data sets can include data measured by the sensors 304 and/or data that is associated with the system components 110 that may or may not have been measured or determined via a sensor including, for example, operational data, historical data, maintenance data, and the like.

The central controller 120 may include a processor 306, a memory 308, a power supply 310, and a gateway node 312. The memory 308 can be configured to store user record information or information received from the one more system components 110 and/or sensors 304, wherein the sensors can be coupled to, or in communication with one or more system components 110, or can be integrated with the one or more system components 110. In some embodiments, the processor 306, the gateway node 312, the memory 308, the power supply 310, and similar processing components can be integrated into a central controller that communicatively operates with the system components 110 and or the sensor(s) 304 to accomplish the processing and data aggregation tasks of the connected system 100. The memory 308 can be implemented as a stand-alone memory unit and/or as part of the processor 306. In some embodiments, the memory 308 can be provided in the form of a database (see, e.g., FIG. 4), as a lookup table, as another data storage configuration, or as a combination thereof.

In some aspects, the power supply 310 can be provided in the form of a battery, a hard-wired connection, a wireless power source, an alternative power source, or a combination thereof. In some forms, the power supply 310 can be provided in the form of rechargeable battery packs or similar rechargeable power source. In some embodiments, the power supply 310 can be adapted to multiple voltage supplies and/or current supplies to accommodate different geographic areas and/or retrofit scenarios.

In some forms, the gateway node 312 can be provided in the form of a network node, hub, router, server, switch, or other connected devices. The gateway node 312 can be configured to process communication signals using multiple protocols or communication connections. In some embodiments, the system 100 can be provided in the form of a mesh network configuration to allow for direct communication in a mesh-connected system 100 without an internet collection and may allow for reduced traffic through the gateway node 312 while maintaining inter-device communication even if internet access is interrupted. In some embodiments, a master/slave configuration can be used to designate specific communication devices.

Furthermore, as one non-limiting alternative to the configuration illustrated in FIG. 3, the central controller 120 may include a programmable processor 306 and/or a network interface 420 and can be electronically coupled to a memory 308 or database 430 device. In some embodiments, the central controller 120 may include program instructions that are stored on a cloud server non-transitory computer-readable medium and that are executable by the programmable processor 306 to perform one or more of the methods described herein.

FIG. 4 is a block diagram of a data management system 400 of the connected system 100. The data management system 400 may include a server 402 and be connected to one or more databases 430, one or more programmable processors 306 and memory units 308, and one or more network interfaces 420. In some embodiments, the one or more databases 430 may be the database 180 in FIG. 1. In some embodiments, the network interface 420 may connect the data management system 400 to the network 140 in FIG. 1. In some embodiments, the one or more programmable processors and memory units can be integrated into one or more of the data management system 400 components including, but not limited to, the server 402 and/or network interface 420.

The server 402 of the management system 400 may include one or more modules including an authentication module 410, a VR/AR module 412, a notification module 414, a training module 416, and an advanced analytics module 418.

As described with respect to the authentication system 160 in FIGS. 1 and 5-8, the authentication module 410 may be used for confirming the identity and account details of the user(s) 170. For example, the authentication module 410 may receive a request and determine if the request is associated with an approved or pre-registered user 170. In some embodiments, the authentication module 410 may determine the access level associated with the user 170 and a time period for the access level and/or determine whether the user 170 has permission to update a parameter of a system component 110 received in a request from the user 170.

The VR/AR module 412 may be used to provide a virtual display of a potential pool or spa system to a user 170. The VR/AR module may be in communication with a VR/AR headset worn by the user 170 or a VR/AR application installed on the user device 130. The user 170 may point the VR/AR headset or the user device 130 at a location on a property and be able to virtually see a potential pool or spa and the associated system components 110 at the location.

As described with respect to the notification system 190 in FIGS. 1 and 5-8, the notification module 414 may be used for creating, modifying, and logging events and system updates for the management system 400 and the connected system 100. The notification module 414 may also generate, update, and push notifications and customized alerts to or from the one or more user devices 130 and/or the third-party applications 150. In one embodiment, the notification module 414 may be configured to be dynamic, scalable, and integrated with one or more third-party applications 150. In some embodiments, the notification module 414 may be configured to receive one or more data sets from one or more data sources or applications, generate one or more notifications, and handle the distribution of the one or more notifications to the applicable data sources, applications, user devices 130, third-party applications 150, or a combination thereof.

In some embodiments, the notification module 414 may be configured to create and monitor new events, wherein each event may be assigned a unique identification tag and time stamp. A notification status may be updated automatically via the management system 400, or in response to receiving a user input, third-party input, or other indication that an event has been modified.

The training module 416 may be designed to execute programmable instructions related to one or more advanced data analysis and modeling processes. In some embodiments, the training module 416 may generate and iteratively train training modules for providing dynamic outputs. For example, in some embodiments, the training module 416 may be configured to perform one or more of the several comparing and determining steps of the processes 500-800 shown and described in connection with FIGS. 5-8. The training module 416 may be configured to generate, train, and execute one or more nodes, neural networks, gradient boosting algorithms, mutual information classifiers, random forest classifications, and other machine learning and artificial intelligence-related algorithms.

In some embodiments, the training module 416 may analyze one or more parameters in the process of iteratively training a learning model or similar advanced training model. When used throughout the present disclosure, one skilled in the art will understand that processes for an “iteratively trained learning model” may include machine learning processes and other similar advanced artificial intelligence processes. For example, the system and processes of the present disclosure may perform automatic configuration and re-configuration of system components, system or component updates, settings or features of the system components, diagnostics, and similar processes. In some embodiments, the training module 416 may use additional inputs and/or feedback loops for an iterative training process.

The advanced analytics module 418 may execute additional data processing techniques and steps, including report generation, troubleshooting, generating customized user display content and/or recommendations according to user data settings and preferences, predictive analytics, historical data, usage data, and other analytics. The advanced analytics module 418 can also be used for relationship-handling processes including automated reminders, scheduling, feedback, and other data processing tasks.

In some embodiments, the connected system 100 can collect and store data sets in the database 430, where the data sets can then be processed by the data processing modules using, in one example, advanced analytics and an iteratively trained learning module. In some embodiments, the data sets can include system component data 432, user data 434, third-party data 436, system data 438, and other data 440.

In at least one embodiment, the data management system 400 receives transmitted data including system component data 432, which can include manufacturer and manufacturer-provided information, model number, serial number, an identification element, a QR code, RFID tag, size or capacity, volume, parts list, coverage or protection information, installation information, configuration information, geographic location, date installed, recommended maintenance procedures and timelines, normal operating thresholds, and error/warning codes. In some embodiments the data management system 400 can obtain additional system component data 432 from the manufacturer of the system component 110 including maintenance procedure, maintenance timelines, tasks, rebates, recalls, common issues, or other data 526. The system component data 432 can further include the operating data obtained from the sensing device(s) or otherwise associated with the individual system components 110 in the description for FIGS. 1-3, although the system component data 432 is not limited to these examples. Additional system component data 432 can be collected, including, for example, service repairs, a maintenance history, usage data, and scheduled updates for a specific system component 110.

In some embodiments, the data management system 400 receives transmitted data including user data 430, which can include but is not limited to personal information about the user, contact information, address, a list or log of the user's specific system components 110, maintenance history information, secondary contact information, payment information, promotional codes, any notes regarding previous service requests (e.g., gate access code, preferred service days/time, previous service technician notes, etc.), and other information. In one embodiment, the user data 430 can be updated to include notification settings, communication preferences, system component settings, historical usage data, programmed settings, schedule settings, renter information, or service information for a specific user, including call logs, diagnostic records, and service history. In some embodiments, the data management system 400 can obtain additional information uploaded to the connected system 100 via the network 140 or network interface 420, where the additional information can include, but is not limited to, photos and descriptions uploaded to the data management system 400 to aid in diagnostics, service, or repair. In some forms, the user data 434 can include images related to past events, social events, or other images.

In some embodiments, a third-party system can obtain access to the user-uploaded information stored in the data management system 400 to facilitate service. In this example, additional authentication processes can be used before providing access to the third-party system. In some embodiments, a third-party system can transmit and upload information to the data management system 400 to be associated with the user's specific system components 110, for example, photos after a service request is completed, notes from a technician, notes from a third party regarding parts, a post-service summary report, a post-service survey, or other aspects of the service request. In some embodiments, the post-service summary report can be generated automatically by one or more processes described with the data management system 400.

In some embodiments, the data management system 400 receives transmitted data including third-party data 436, where the third party can be a dealer, which can include information about the third party, brands serviced, repair and service capabilities, profile information including descriptions regarding service and request handling techniques and priorities, invoicing and payment information, contact information, address, geographical regions located or serviced, a list or log of the third-party's specific system components 110 issues completed, maintenance history information, maintenance procedures and timelines, manufacturer information, part supply, number of available technicians, certifications, scores, and other information. In one embodiment, the third-party data 436 can be updated to include notification and communication preferences and settings and historical usage data for a specific user or servicer, or technician, including call logs, denied service requests, and service history. Third-party data 436 can further include information and operating parameters related to specific system components 110 installed in connected systems of other users, which can be used by the connected system 100 to intelligently recommend updates to the system components 110 (e.g., software patch update, setting configuration update resulting in average decline in energy usage, etc.).

In one embodiment, a third party can install an application on a device or otherwise integrate a third-party system with the data management system 400. A third party can set up a record (i.e., dealer record, rental record, etc.) when the third party is an authorized servicer, renter, or dealer related to one or more of the system components 110. In some embodiments, the third-party data 436 can be updated in the data management system 400 as the third party updates the information in the third-party record. A user can also authorize one or more third parties to obtain access to some aspects of the user's account information stored in the data management system 400.

In some embodiments, the data management system 400 receives transmitted data including system data 438, which can include but is not limited to the status, health, and connection of the various aspects of the connected system 100, including the connectivity information between each of the system components 110 and the network interface(s) 420. The system data 438 can further include troubleshooting or general questions regarding the user or a third-party interface.

In some embodiments, the data management system 400 receives transmitted data including other data 440, which can include data sets not described in connection with the other transmitted data categories described. The data sets can include historical information, usage reports, engagement information, event logs, parts supply, or any other data 440 that can be used by the data management system 400 or other aspects of the connected system 100.

FIG. 5 illustrates a data management process 500 of the connected system 100 described in connection with FIG. 1. The data management process 500 may be designed to process one or more data sets received from aspects of the connected system 100 including one or more of the system components 110, the user device(s) 130, and/or one or more third-party applications 150.

At step 510, the authentication system 160 may receive an indication signal of a new request or event from inputs received from one or more of the third-party applications 150. In one embodiment, the indication signal may be sent by the connected system 100 in response to receiving and storing one or more data items within the data sets associated with a new request or event at the database 180. In some embodiments, the new request or event may be a log-in request for a user 170 and/or a request to initiate authentication of the user 170.

At step 520, the authentication system 160 may determine the access level for the user 170 associated with the log-in request. The access level may be associated with a time period during which the access level is provided to the user 170. In some embodiments, the authentication system 160 may generate a portal associated with that access level and the time period. The process of authenticating a user 170 is described in more detail in connection with the authentication process 600 of FIG. 6.

At step 530, the connected system 100 may be configured to retrieve and filter one or more data items within the data sets received with the new request from the database 180. The request may include one or more parameter update requests, parameter setting updates, user preferences, user information, or other information. In another embodiment, the request may be submitted via one or more third-party applications 150 or one or more user devices 130, and at step 530 the data sets included in the request submission may be processed and stored in the database 180.

The one or more data items within the data sets and/or other information received in the request may be provided, transmitted, or otherwise communicated to the one or more third-party applications 150 associated with one or more third-party systems or services for processing at step 550.

In some embodiments, a user 170 may use a VR/AR system 195 communicatively coupled or otherwise connected to the connected system 100. The VR/AR system 195 may be a separate system or the VR/AR system 195 may be contained within one or more third-party applications 150. In one non-limiting example, the user 170 may submit a request to see a visual representation of an installed pool or spa system on a property the user 170 owns or manages. In this example, at step 550, the one or more data sets associated with the user's request may include visualization data such as a lot size, physical parameters of the property, a pool or spa type, size, and/or style, location data, etc. In some embodiments, the one or more data sets may be sent to one or more third-party services via a third-party application 150 to generate a VR/AR output for the user 170 to view.

In some embodiments, the VR/AR system 195 may be communicatively coupled or otherwise connected to the controller 120. In some embodiments, the VR/AR system 195 may be in communication with a VR/AR application stored on or otherwise accessible via the one or more user devices 130 and/or a VR/AR headset that may be worn by the user 170 and/or the VR/AR module 412 of the server 402. In some embodiments, for example, the VR/AR headset may be a META QUEST™ PRO VR headset, a META QUEST™ 2 VR headset, a META QUEST™ 3 VR headset, an HTC VIVE® PRO 2 VR headset, a SONY® PLAYSTATION® VR2 headset, a VALVE INDEX™ VR headset and the like. In other embodiments, the VR headset may be a device designed specifically for use with the VR/AR system 195.

In some embodiments, the visualization data may be received by and/or sent to the VR/AR application or the VR/AR headset from the VR/AR system 195, or the visualization data may also be received by and/or sent to the VR/AR system 195 from the VR/AR application or the VR/AR headset. In some embodiments, the visualization data may be stored in the VR/AR module 412 of the server 402. For example, a user 170 wearing a VR/AR headset or using a VR/AR application on a user device 130 may point or otherwise direct the VR headset or the user device 130 to a certain location on a property. In this example, the VR/AR system 195 may output a virtual display that shows a potential pool or spa on the property at the location at which the VR/AR headset or user device 130 was pointed or directed. The VR/AR system 195 may also output a virtual display or a list of possible system components 110 for the potential pool or spa virtually displayed. The potential pool or spa and the possible system components 110 may be viewable virtually via the VR/AR headset or the user device 130.

In some embodiments, the VR/AR system 195 may enable the user 170 to add or remove certain system components (e.g., a water feature 255 or solar panels 285) shown in connection with the virtual pool or spa displayed to the user 170 via the VR/AR headset or the user device 130. The VR/AR system may also provide a cost estimate for the virtual pool or spa and possible system component configurations for the virtual pool or spa. The VR/AR system 195 may further output a virtual display of alternate locations or layouts of the potential pool or spa, as well as alternate configurations of the system components. In some embodiments, the VR/AR system 195 may provide the user 170 with a visual indication of what would happen if certain components are added or changed (e.g., enable the user to virtually see what happens when the pool pump 230 is upgraded or a water feature 255 or pool lights 260 are added). Furthermore, the VR/AR system 195 may also enable the user 170 to save one or more virtual pool or spa layouts and system component configurations and share the layouts and configurations with a third-party service (e.g., a builder or technician) via a third-party application 150. In some embodiments, the virtual pool or spa layout and associated system components may be saved to the database 180.

In another embodiment, a property owner or host may be an authorized user 170 who submits a request to a third-party pool dealer for pool or spa service or maintenance. In this example, the one or more system components 110 may be configured to monitor one or more operating parameters and determine when a specific system component 110 needs servicing or repair, initiate a service request, and transmit the related data set or other information to one or more dealers or technicians via third-party services at step 550. The system may automatically or with input from the property owner or host provide the dealer or technician with an access level for a time period suitable for the dealer or technician to access the pool or spa system and/or any of the one or more system components 110 in need of servicing or repair. In some embodiments, the property owner or host or the dealer or technician may be able to view, manage, and/or monitor pool or spa equipment through the data sets (e.g., system component data 432) stored in the database 180 through one or more third-party applications 150.

At step 560, the central controller 120 may receive third-party data 436 from the one or more third-party applications 150 to fulfill the request, process the third-party data 436, identify missing, incorrect, or incomplete information for fulfilling the request, and may either repackage and distribute the request or identify the information as missing and sends an error notification request to the notification system 190 to generate a notification message. In some embodiments, the third-party data 436 received at step 560 may include information related to a unique identifier associated with an authorized user 170 who has paid a deposit and/or signed a short-term rental agreement for access to a property. In some embodiments, the third-party data 436 may also include an access level associated with the user 170 and a time period associated with the access level. In some embodiments, the access level and time period for the access level may be contained within the short-term rental agreement signed by the user 170.

In step 570, the connected system 100 may write the third-party data 436 to the database 180. In some embodiments, the connected system 100 may transform the received third-party data 436 before writing to the database 180. In some embodiments, the database 180 may transform the data. When used throughout the present disclosure, one skilled in the art will understand that “transform” may include normalizing, standardizing, and other advanced analysis techniques for manipulating the data such that the data can be processed, analyzed, and used to generate customized outputs according to the present disclosure. In at least one embodiment, the data transformation may include one or more data modifications such as imputing missing data; converting data to one or more formats (e.g., for example, converting string data to numeric data); removing extra characters; formatting data to a specific case (e.g., for example, converting all uppercase characters to lowercase characters); normalizing data formats; and anonymizing data elements.

In step 580, the connected system 100 may transmit the third-party data 436 or a portion of the third-party data 436 and/or one or more datasets to the notification system 190. The connected system 100 may send the portion of the third-party data 436 and the one or more data items associated with the request from the database 180 (e.g., where the information was written/stored) to the central controller 120 to be packaged and transmitted to the notification system 190.

In step 590, the notification system 190 may receive the third-party data 436 and initiate a notification sequence, which generates a notification. The notification generated by the notification system 190 may be transmitted via a notification API to be displayed by either the one or more user devices 130 and/or any of the one or more third-party applications 150.

FIG. 6 illustrates an authentication process 600 of the connected system 100 described in connection with FIG. 1. In some embodiments, the authentication process 600 may be executed by the authentication system 160 (or the authentication module 410) and may include steps for receiving and processing a request submitted by a user 170. The authentication system 160 may determine whether the request was transmitted by an approved or pre-registered user by verifying identification credentials like username and password, or other suitable methods of identity authentication.

At step 610, the authentication system 160 may receive a request and determine if the request is associated with an approved or pre-registered user 170 by sending a request to the database 180 and determining if the data items associated with the log-in request match one or more data items stored in the database 180. In some aspects, the data items associated with the log-in request can be compared to data items stored in the user data 434 of the database 180. If the data items match, the authentication system 160 authenticates the log-in request and retrieves the stored unique identifier and access level associated with the user 170 and an associated time period for the access level from the database 180. In some embodiments, the authentication system 160 may generate an authentication message and/or communicate the authentication to the notification system 190. The notification system 190 may generate and display an authentication approval message to the user 170 via the one or more user devices 130 or another display device. If the credentials do not match an approved or pre-registered user 170, the authentication system 160 may deny access to the connected system 100 or the one or more system components 110. In some embodiments, the authentication system 160 may generate an error message and/or communicate the error to the notification system 190. The notification system 190 may generate and display an authentication error message to the user 170 via the one or more user devices 130 or another display device. The failed authentication attempt may further be transmitted and stored in the database 180.

In some embodiments, the authentication system 160 may determine if a request is associated with an approved or authorized user 170 by comparing the unique identifier associated with the user 170 with one or more third-party applications 150. In one non-limiting example, if the user 170 has a short-term property rental arranged through the third-party application 150 (e.g., AirBnb, VRBO, SWMLY, etc.), the authentication system 160 may receive a request to activate the pool lights 260 or other system components 110 during a certain time period, and may verify the user 170 submitting the request is authorized based on the calendaring service of one or more third-party applications 150.

At step 620, the authentication system 160 may determine the access level associated with the user 170 and a time period for the access level. In some embodiments, the authentication system may generate a portal associated with that access level. In some embodiments, a property owner or host's user portal and available system settings may appear differently than a short-term renter or a third-party servicer. In addition, a property owner or host may have no specific time period associated with their access level, whereas a short-term renter may only have a particular access level during a certain time period. The time period for the short-term renter's access level may be specified in a short-term rental agreement and/or by the property owner or host via a third-party application 150. For example, if a short-term renter has rented a property for three days, the access level provided to the short-term renter may only be available during the three-day rental period. In one non-limiting example, the time period for the access level for the short-term renter may begin at a check-in time and end at a check-out time specified by the rental agreement or by the property owner or host. In some embodiments, the portal may be generated and/or displayed on the one or more user devices 130.

At step 630, the authentication system 160 may receive and process data items a user inputs into specified fields in a request form for the request. In some embodiments, the data items may be one or more parameter updates. In one non-limiting example, the user input may include a request to turn on the spa heater 250, wherein the temperature of the spa is a parameter update, and the controls and signals associated with that parameter update request may be provided in the form of one or more data items submitted in the request by the user 170. Specific parameter settings related to specific system components 110 and other configuration characteristics of the connected system 100 may be stored in the system component data 432 of the database 180 and controlled by the central controller 120 or other aspects of the connected system 100.

At step 640, the authentication system 160 may determine the access level of the user 170 and compare the parameter settings in the submitted request with the parameter settings associated with a particular access level and/or a specific unique identifier stored in the database 180.

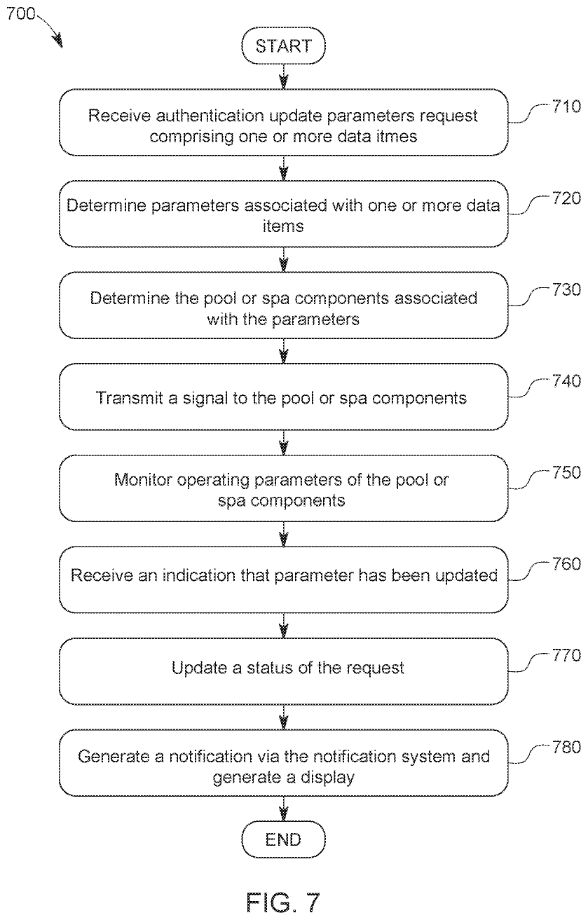

If the user 170 is determined to have an appropriate access level, then the system will update the parameter as requested at step 660. The parameter may be updated according to a parameter update process 700 discussed in more detail with respect to FIG. 7. If the user 170 is determined not to have the appropriate access level, then the system will not update the parameter as requested at step 660.

In some instances, the user 170 may not have permission to update the parameter as requested. For example, a short-term renter may only have permission to turn on/off the spa system, but not be able to control the temperature of the spa. In this example, depending on the particular parameter settings, the central controller 120 may turn on the spa at step 650 but generate a notification via the notification system 190 at step 680 to the user 170 that the temperature will not be adjusted due to permission settings or access level. At step 670, the central controller 120 may receive a signal that the spa has been turned on (in this non-limiting example) but that the temperature is not being adjusted.

In another example, if the user 170 tries to override a setting that the user 170 does not have permission to adjust, the authentication system 160 will verify an impermissible access level at step 640 and may ignore the request to update the parameter at step 660 and send a signal that the request cannot be completed due to access level at step 670. A notification may be generated via the notification system 190 at step 680 to the user 170 via a user device 130 that the parameter is not being adjusted.

In some embodiments, if a user 170 does not have permission to update, modify, or change a parameter of one or more system components 110, the user 170 may send a request to the one or more third-party applications 150, or the property owner or host, via the user device 130 requesting that the user's access level be upgraded so that the user 170 has permission to update, modify or change a parameter for one or more system components 110. For example, a short-term renter may want to change the temperature of the pool or spa, but the short-term renter's access level does not allow the short-term renter permission to adjust the pool or spa's heater 250. In this instance, the user 170 may send a request via one or more third-party applications 150 or directly to the property owner or host requesting that an upgraded access level be granted so that the short-term renter can adjust the pool or spa's heater 250 upon approval of the request.

In some embodiments, the upgraded access level may be associated with an additional rate or an additional agreement (e.g., a waiver or assumption of liability) that the user 170 may be asked to agree to before the upgraded access level is granted. In addition, in some embodiments, the upgraded access level may have a time period that is the same or different from the time period associated with the original access level. For example, if the short-term renter is renting the property for one week, the upgraded access level may be requested and granted for the entire week, may be requested and granted for less than the entire week (e.g., one or more days or hours), or may be requested for an entire week, but only granted for a certain number of days or hours. In some embodiments, the upgraded access level may be reviewed and/or approved via one or more third-party applications 150. In other embodiments, the property owner or host may be required to provide final approval before the upgraded access level is granted. In further embodiments, the property owner or host may waive any additional rates or agreement formalities. Once the additional rate is collected and/or the additional agreement is signed by the user 170, or the property owner or host has otherwise approved the request and/or waived any additional items for the requested upgraded access level, the third-party application 150 may send updated data items for the upgraded access level to the authentication system 160, which may be stored in the database 180.

FIG. 7 illustrates a parameter update process 700 for updating one or more operating parameters associated with one or more system components 110 in response to receiving an authenticated update parameter request submission.

At step 710, the central controller 120 may receive an authenticated update parameter request submission including one or more data items. In some embodiments, the authenticated update parameter request submission has already been verified in relation to the access level (or upgraded access level) associated with the permissions needed to update the parameter according to the authentication process 700 described in connection with FIG. 6.

At step 720, the one or more parameters associated with the one or more data items may be extracted from the authenticated update parameter request submission and may be processed using the central controller 120, the database 180, or another aspect of the connected system 100. As illustrated in an earlier non-limiting example, the authenticated update parameter request submission may be provided in the form of turning on the spa system and setting the spa system to a particular temperature. The parameters associated with the authenticated update parameter request submission may include, for example, a power-on function of the spa system components 110 and a parameter for the temperature setting. Additionally, the one or more data items associated with the authenticated update parameter request submission may include, for example, the sensed current temperature, the other operating parameter of connected or related system components 110 that may impact or otherwise need to be activated/deactivated while the spa is heating or operational, or similar data items.

In some embodiments, the one or more data items extracted from the authenticated update parameter request submission may include one or more system components 110 and date and time information associated with a parameter update for the one or more system components 110. For example, the one or more data items in the authenticated update parameter request submission may include one or more system components 110 to which the parameter update is to be applied, an arrival or start date for the parameter update, a departure or end date for the parameter update, a check-in or start time for the parameter update, and a check-out or end time for the parameter update. The parameter update may be, for example, the turning on/off of one or more system components 110 or the setting of one or more system components 110 to a particular setting based on the arrival/start date, the departure/end date, the check-in/start time, and/or the check-out/end time provided in the authenticated update parameter request submission.

In one non-limiting embodiment, if a short-term renter has rented a property for a week, starting on a Sunday and ending on the following Saturday, where the check-in time is 4:00 pm on Sunday and the check-out time is 11:00 am on the following Saturday, the central controller 120, based on the data items received in the authenticated update parameter request submission, may send a signal to turn on one or more system components 110 (e.g., the pool or spa heater 250 or pump 230) before or at the check-in time (e.g., 4:00 pm) on the arrival date (e.g., Sunday) so that the one or more system components 110 reaches a desired state or setting (e.g., the pool or spa is heated to a certain temperature) at the time of the short-term renter's arrival. The central controller 120 may also send a signal to turn off one or more system components 110 (e.g., the pool or spa heater 250 or pump 230) or set the one or more system components 110 to a certain setting at the check-out time (e.g., 4:00 pm) on the checkout date (e.g., Saturday) or when the short-term renter has checked out using a third party application 150. If the short-term renter checks out using a third-party application 150, then a notification of the check-out may be sent from the third-party application 150 to the controller 120 via the network 140 or the notification system 190.

Furthermore, in another non-limiting embodiment, if a short-term rental property is regularly rented on a certain schedule, for example, has an arrival date on a specific day of the week (e.g., Sunday) and a departure date on a certain day of the week (e.g., Saturday) and a certain check-in time and check-out time on the arrival date and departure date, respectively, the connected system 100 may be trained or may intelligently learn to automatically turn one or more system components 110 on/off or set one or more system components 110 to a certain setting on a certain date and/or time-based on the rental history for the short-term rental property. Various analytics tools may be used to train the connected system 100 as discussed in more detail with respect to FIG. 4.

At step 730, the central controller 120 may determine the specific system components 110 related to the authenticated parameter update request submission and, at step 740, the central controller 120 may transmit or otherwise communicate a signal to the system components 110. The signal may be transmitted via a communication link, as described in more detail in connection with FIG. 1.

At step 750, the connected system 100 may monitor one or more operating parameters of the connected system 100. In some embodiments, the monitoring step may occur continuously, or only in response to an update signal being transmitted in step 740. In some embodiments, the monitoring may be completed by one or more sensing devices or sensors 304. The sensor(s) 304 or one or more sensing devices may be integrated with the one or more system components 110, as described in connection with FIGS. 2 and 3.

At step 760, once the parameter update has been executed, as determined and verified by the monitoring step 750, the central controller 120 (or other aspects of the connected system 100) may receive a signal from the sensing devices and/or the system components 110 that the parameter has been updated according to the authenticated parameter update request submission.

At step 770, the central controller 120 may update the status of the request to indicate that the authenticated parameter update request submission has been completed and transmit that status to the notification system 190, and at step 780, the notification system 190 may generate a notification and generate a display on the one or more user devices 130 and/or the third-party applications 150 to indicate the parameter has been updated.

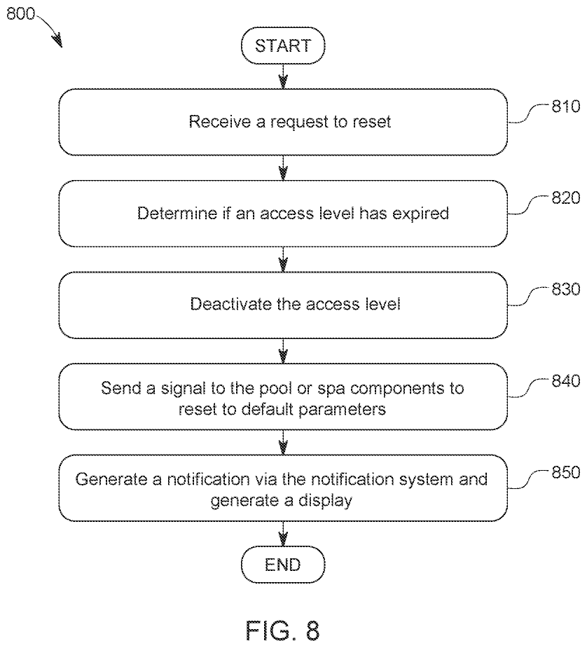

FIG. 8 illustrates a system reset process 800 of the connected system of FIG. 1. The system reset process 800 may be initiated at step 810 when a request to reset is received. In one embodiment, the request to reset may be received from a third-party application 150. The request from the third-party application 150 may include a third-party data set that includes information indicating that a short-term rental has expired, or the time period associated with the access level or upgraded access level has ended. In this example, the authentication system 160 may no longer recognize a particular user 170 as an authorized user with an access level or an upgraded access level. In some embodiments, the system reset process 800 may be initiated when a user 170 tries to update a parameter according to the processes described in connection with FIGS. 6 and 7, but the user 170 does not have the required access level. In this example, the request to reset may be sent by the authentication system 160.

In another embodiment, the system reset process 800 may be initiated in response to a user 170 restoring the connected system 100 to one or more default settings. In this example, after the user 170 is authenticated using the authentication system 160, the user 170 may send a request to reset at step 810.

At step 820, the central controller 120 or the authentication system 160 may compare the third-party data 436 received in the request to reset to data items stored in the database 180 to confirm that the access level for a user has expired.

The system reset process 800 may include deactivating an access level of one or more users 170 at step 830. For example, a property owner or host may attempt to reset the pool lights 260 to a default setting, and the access level for the property owner or host is not impacted at step 830, but the access level for the short-term renter may be verified as expired and removed at this step.

At step 840, the central controller 120 may transmit or otherwise communicate a signal to the one or more system components 110 to their default settings. In some embodiments, this may include the primary user's (e.g., the property owner or host's) parameter settings stored in the database 180. In other embodiments, this may include the factory and/or manufacturer default settings.

At step 850, the central controller 120 may update the status of the request to reset to indicate that the request has been completed and transmit that status to the notification system 190 to generate a notification and generate a display on the one or more user devices 130 and/or the third-party applications 150 to indicate the parameter has been updated and/or that the system has been reset.

In other embodiments, other configurations are possible. For example, those of skill in the art will recognize, according to the principles and concepts disclosed herein, that various combinations, sub-combinations, and substitutions of the components discussed above may provide appropriate control for a variety of different configurations of connected systems and computer architectures for control and management of data communicating with aquatic equipment, and so on, for a variety of applications.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A connected aquatic system for managing requests from one or more disparate applications, comprising:
a pool component;
a central controller in communication with the pool component and designed to execute programmable instructions including:
connecting the pool component to a cloud-based server via a network;
establishing a communication link between the cloud-based server and a disparate application;
receiving a request from the disparate application, wherein the request includes a plurality of third-party data; and
in response to receiving the request, providing access to the pool component based on the plurality of third-party data, wherein the third-party data comprises an access level.

2. The system of claim 1 further comprising an authentication system that is in communication with the central controller.

3. The system of claim 2, wherein the authentication system determines the access level and wherein the access level is associated with a user.

4. The system of claim 1, wherein a request for a user to update a parameter of the pool component is received by the central controller via the disparate application.

5. The system of claim 4, wherein the parameter is turning the pool component on or off.

6. The system of claim 4, wherein the request is sent to an authentication system in communication with the central controller to determine if the access level permits the user to update the parameter of the pool component.

7. The system of claim 6, further comprising a notification system that is in communication with the central controller.

8. The system of claim 7, wherein the notification system generates a notification that the parameter of the pool component is updatable by the user based on the access level and sends the notification to a user device via the central controller.

9. The system of claim 1, wherein the pool component can be provided in a form of a pool pump, a booster pump, a filter, a solar controller, one or more solar panels, a heater, a sanitizer, a water quality monitor, a pH regulator, a salt chlorine generator, a water feature, a pool cleaner, a pool skimmer, a pool drain, a pool light, one or more valves, one or more sensors, or a combination thereof.

10. The system of claim 1, wherein the disparate application can be provided in a form of an application for payment services, calendaring services, scheduling services, short-term rental services, virtual reality platform services, contracting services, pool equipment dealer services, pool chemical services, or a combination thereof.

11. The system of claim 1, wherein the third-party data further comprises a unique identifier for a user and a time period for the access level, wherein the access level and the time period for the access level are associated with the unique identifier for the user.

12. The system of claim 1, further comprising a database that is in communication with the central controller.

13. The system of claim 1, wherein the third-party data is stored in a database.

14. A method of communicating between disparate applications within a connected aquatic system, comprising:
providing a pool component in communication with a controller;
connecting the pool component to a cloud-based server via a network using the controller;
establishing a communication link between the cloud-based server and a disparate application using the controller;
receiving a request from the disparate application using the controller, wherein the request includes a plurality of third-party data; and
in response to receiving the request, providing access to the pool component based on the plurality of third-party data, wherein the third-party data is associated with a particular access level.

15. The method of claim 14 further comprising the step of monitoring and reporting parameters associated with the pool component to the disparate application.

16. The method of claim 15, wherein the parameters associated with the pool component include usage data for the pool component.

17. The method of claim 15, further comprising the step of authenticating a user via an authentication system in communication with the controller, wherein the user is associated with the access level, and the authentication system determines whether the access level enables the user to change the parameters associated with the pool component.

18. The method of claim 17, further comprising the step of sending a notification to a user device of the user via a notification system in communication with the controller, wherein the notification indicates that the user is able to change the parameters associated with the pool component based on the access level.

19. The method of claim 14, wherein the disparate application comprises an application for payment services, calendaring services, scheduling services, short-term rental services, virtual reality platform services, contracting services, pool equipment dealer services, or pool chemical services.

20. A system for communicating between disparate applications within a connected aquatic system, comprising:
a pool component in communication with a central controller designed to control the pool component upon receipt of an authorized request;
a cloud-based server operatively connected to the controller and the pool component;
a connection to a disparate application provided in a form of a third-party application;
an authentication system designed to process a request from the disparate application, wherein the request includes access level data;
a database designed to store authorized user information; and
a controller to perform the steps of:
comparing the access level data to the authorized user information;
determining whether to authenticate the request based on whether the access level data matches the authorized user information; and
generating a notification to the central controller when the request is the authorized request based on determining the access level data matches the authorized user information.
